(19) United States
(12) Patent Application Publication
(10) Pub. No.: US 2025/0111306 A1
(43) Pub. Date: Apr. 3, 2025

(54) WORKFORCE SCHEDULING BASED ON SHIFT ENUMERATION

(71) Applicant: UKG Inc., Weston, FL (US)

(72) Inventors: Ahmed Hadjar, Laval (CA); Beyime Tachefine, Montreal (CA); Eunice Lemamou, Montreal (CA); Pierre Montulet, Montreal (CA); Salomon Bendayan, Montreal (CA); Sylvie Gelinas, Montreal (CA)

(21) Appl. No.: 18/812,467

(22) Filed: Aug. 22, 2024

Related U.S. Application Data
(60) Provisional application No. 63/541,437, filed on Sep. 29, 2023.

(51) Int. Cl. G06Q 10/0631

(52) U.S. Cl. CPC G06Q 10/063116

(57) ABSTRACT

An example method of workforce scheduling includes: identifying a plurality of variables associated with scheduling a plurality of workers to perform a plurality of jobs during respective shifts defined by corresponding time periods, wherein each variable is associated with a corresponding shift; identifying a scheduling problem for optimizing an objective function defined on the plurality of variables subject to a plurality of constraints; identifying, based on a historic schedule assigning at least a subset of the plurality of workers to perform at least a subset of the plurality of jobs during a plurality of past time periods, a subset of the plurality of variables; determining, based on the subset of the plurality of variables, a tentative solution of the scheduling problem; responsive to determining that the tentative solution fails a predefined quality criterion, modifying the tentative solution; and generating a schedule based on the modified tentative solution.

### REFERENCE TO RELATED APPLICATIONS

This application claims the benefit of U.S. Provisional Application No. 63/541,437, filed Sep. 29, 2023, which is incorporated by reference herein.

### TECHNICAL FIELD

Embodiments of the present disclosure relate to computing systems, and more specifically, to methods and systems for shift enumeration-based workforce scheduling.

### BACKGROUND

Successful functioning of an organization (e.g., an enterprise, such as a manufacturing company, a retail company, or a service provider) depends on its ability to perform efficient scheduling, i.e., assignment of jobs to workers (including employees, temporary workers, independent contractors, and/or other categories of workforce) during specified time periods (“shifts”). The scheduling problem is a nondeterministic polynomial-time hard (NP-hard) optimization problem.

### BRIEF DESCRIPTION OF THE DRAWINGS

The disclosure is illustrated by way of example, and not by way of limitation, and may be more fully understood with references to the following detailed description when considered in connection with the figures, in which:

FIG. 1 schematically illustrates an example scheduling problem represented in a form solvable by the systems and methods of the present disclosure.

FIG. 2 depicts a flow diagram of an example workflow 200 of solving a workforce scheduling problem by decomposition, in accordance with aspects of the present disclosure.

FIG. 3 depicts a flow diagram of an example method of generating a workforce schedule by shift enumeration, in accordance with aspects of the present disclosure.

FIG. 4 schematically illustrates a high-level diagram of an example distributed computer system, which may implement the methods described herein.

FIG. 5 is a block diagram illustrating a computing system in which implementations of the disclosure may be used.

### DETAILED DESCRIPTION

Successful functioning of an organization (e.g., an enterprise, such as a manufacturing company, a retail company, or a service provider) depends on its ability to perform efficient scheduling, i.e., assignment of jobs to workers (including employees, temporary workers, independent contractors, and/or other categories of workforce) during specified time periods (“shifts”). Various approaches to scheduling result in nondeterministic polynomial-time hard (NP-hard) optimization problems. Starting from a certain dimensionality of the problem, not only the brute force approach but also various more efficient mathematical programming approaches would result in a prohibitively large computational resource consumption and/or time required to yield even a suboptimal solution.

To address the above-noted and other deficiencies of various scheduling problem solutions, the systems and methods of the present disclosure implement several heuristic approaches which result in substantially better performance, thus allowing efficient generation of workforce schedules for small-scale scenarios (e.g., when the number of workers and/or the number of jobs is below respective predefined thresholds, such as 50 workers and/or 5 jobs. The techniques described herein may be used in various workforce management applications.

“Schedule” herein broadly refers to a data structure specifying allocation of resources to jobs during specified time periods (“shifts”). Resources may include, e.g., human resources (workers), equipment, and/or materials. Thus, in some implementations, a schedule may be represented by a finite set of n-tuples <shift-idᵢ, job-idⱼ, resource-idₖ, . . . >, where Shift-id is an identifier of the shift, which may be represented by the shift start time and the shift end time, the shift start time and the shift duration, the shift sequential number (such as an index in a chronologically ordered reference list of shifts) or any other suitable identifying information; Job-id is an identifier of the job, which may be represented by an index in a reference list of jobs or any other suitable identifying information; and resource-id is an identifier of a resource (e.g., a worker, such as an employee, a temporary worker, an independent contractor, a volunteer, etc.). A tuple <shift-idᵢ, job-idⱼ, resource-idₖ> means that the resource identified by resource-idₖ has been assigned to perform the job identified by job-idⱼ during the shift identified by the shift-idᵢ . . . . In some implementations, job-idⱼ may be represented by a list of job identifiers, thus allowing to schedule multi-job shifts.

While the schedules in the examples described herein are based on 3-tuples that include the shift identifier, the job identifier, and the resource identifier, in various other implementations the schedule-forming tuples may include a different number of elements. In some implementations, a schedule can be visually rendered by a rectangular table, the columns of which correspond to shifts (e.g., identified by the start date/time and end date/time) and the rows of which correspond to workers. A cell of such a table may store an identifier of a job assigned to the worker associated with the row during the shift associated with the column. In various other implementations, other data structures may be involved for storing and/or visually rendering schedules generated by systems and methods of the present disclosure.

In an illustrative example, the scheduling problem may be represented as a mixed integer linear programming (MILP) problem, which may be formally defined as follows:

Minimize z=c^{T}×subject to Ax=b,x≥0, x∈ [symbol] ⁿ for at least some xᵢ
where z is the objective function (e.g., based on a chosen quality metric characterizing, e.g., the job coverage and the worker satisfaction);
b and c are vectors of real numbers (c∈ [symbol] ⁿ, b∈ [symbol] ^{m}); and
A is a matrix of real numbers (A∈ [symbol] ^{m×n}); and
[symbol] ⁿ is a n-dimensional integer space.

The decision variables may represent worker assignments to particular jobs during particular shifts. The constraints may represent various applicable scheduling rules. The objective function may reflect the overall quality of the schedule and may be composed by a set of additive terms representing respective soft constraints derived from applicable scheduling rules.

Techniques for solving the scheduling problem may be chosen based on its dimensionality (e.g., defined by the number of workers, the number of jobs, and/or the timespan to be scheduled). In some implementations, if the dimensionality of the scheduling problem falls below a certain threshold dimensionality, the scheduling may be solved by combinatorial methods based on an initial solution that is determined by enumerating candidate shifts, as described in more detail herein below. The threshold dimensionality for choosing the shift enumeration technique may be determined to satisfy relevant resource and time-based criteria.

In some implementations, an initial set of shift may be generated by enumerating the candidate shifts based on a historic schedule. The shift enumeration may involve identifying, for each worker, historic shifts in which the worker was assigned to work one of their most frequently worked jobs. Then, candidate shifts may be generated, such that each candidate shift would begin and/or end within a certain timeframe from respective start or end times of a historic shift. In some implementations, in order to improve the quality of the initial set of shifts, the candidate shifts may be filtered based on comparing their start/end time with demand rise/drop times and/or based on chosen quality criteria.

The initial set of shifts may then serve to identify a corresponding subset of decision variables, which would be utilized to define the optimization problem. The optimization problem may then be solved, as a MILP problem, by applying mathematical programming techniques. The resulting tentative solution of the optimization problem may then be modified in an attempt to attain the desired quality of the tentative schedule. Modifying the tentative solution may involve applying one or more local neighborhood search methods (e.g., increasing or decreasing a scheduled shift by a small period of time, such as one hour; moving the start of a scheduled shift by a small period of time, such as one hour; or swapping two scheduled shifts) in an attempt to improve the value of the objective function.

Should the modified tentative solution fail to exhibit the desired quality, the subset of variables of the scheduling problem may be modified by re-enumerating at least a subset of the shifts based on identified weaknesses in the tentative schedule. The new enumerated shifts may then be appended to the subset of shifts, and the MILP problem may be solved again based on the modified subset of shifts.

Various aspects of the methods and systems are described herein by way of examples, rather than by way of limitation. The systems and methods described herein can be implemented by hardware (e.g., general purpose and/or specialized processing devices, and/or other devices and associated circuitry), software (e.g., instructions executable by a processing device), or any combination thereof.

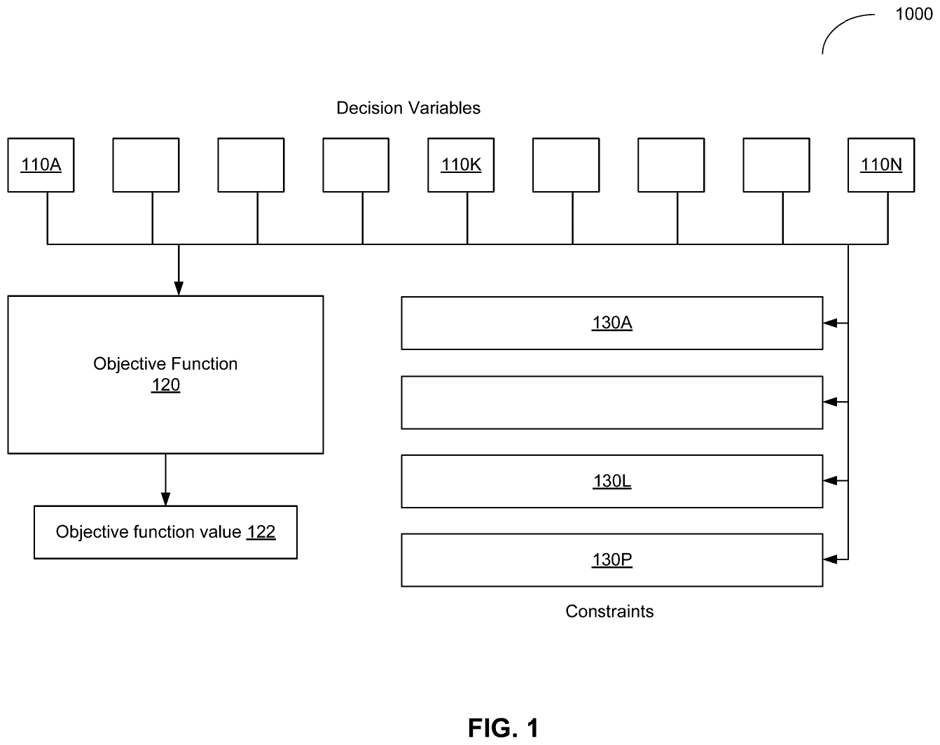

FIG. 1 schematically illustrates an example scheduling problem represented in a form solvable by the systems and methods of the present disclosure. As noted herein above, the example scheduling problem may be represented as a mixed integer linear programming (MILP) problem, which is formally defined as follows:

Minimize z=c^{T}×subject to Ax=b, x≥0, x∈ [symbol] ⁿ for at least some xᵢ.

Thus, as schematically illustrated by FIG. 1, the scheduling problem 1000 optimizes the objective function value 122 of the objective function 120 subject to the constraints 130A-130P. Both the objective function 120 and constraints 130A-130P are defined on a set of decision variables xᵢⱼ 110A-110N.

The decision variables 110A-110N may represent worker assignments to particular jobs during particular shifts. In an illustrative example, one or more decision variables may be represented by respective Boolean values (e.g., indicating whether a particular worker is assigned to work during a particular shift). In another illustrative example, one or more decision variables may be represented by respective integer values (e.g., the number of workers assigned to perform a particular job during a particular shift, the number of workers assigned to perform any work during a particular shift, the number of workers starting work during a particular period of time, the number of workers finishing work during a particular period of time, the number of occurrences of a particular event during a certain time period for a particular worker-such as the number of working nights, the number of consecutive working nights, the number of working weekends, the number of consecutive working weekends, the number of occurrences of more than a predefined number of consecutive working nights, etc.).

As noted herein above, the scheduling process is governed by various scheduling rules of different nature, scope, imperativeness, authority, etc. Sources of the scheduling rules may include applicable laws, regulations, policies, contracts, customary business practices, etc. Accordingly, while some of the rules may be translated to “soft” constraints that are represented by respective additive terms of the objective function, while other rules may be translated into “hard” constraints.

Thus, the objective function may reflect the overall quality of the schedule and may be composed by a set of additive terms representing respective soft constraints. In some implementations, these additive terms may be weighted by a set of coefficients reflecting their respective importance levels.

In some implementations, one or more “soft constraints” may be related to job coverage, which may be defined by the share of all the shift and job combinations that have been “covered,” i.e., assigned). Accordingly, one or more job coverage rules may require at least respective specified levels of job coverage to be achieved for specified jobs (or job categories) during various periods of time. In an illustrative example, the job coverage rules may require that the full (100%) job coverage for mission critical jobs be provided at all times; at least a first predefined level below the full coverage (e.g., 90%) job coverage be provided for essential jobs during high demand periods and at least a second predefined level below the first predefined level (e.g., 80%) job coverage be provided for essential jobs outside of high demand periods; and at least a third predefined level below the first predefined level (e.g., 75%) job coverage be provided for non-essential jobs at all times. These rules may be translated into respective additive terms of the objective function, such that each additive term would reflect the difference between the requisite job coverage and the actual job coverage achieved by the schedule for a particular category of jobs during a particular time period. These additive terms may be weighted by a set of coefficients reflecting the job category (e.g., the highest weight coefficient may be applied to mission critical jobs, the next highest weight coefficient may be applied to essential jobs, and the lowest weight coefficient may be applied to other jobs) and/or the demand aspect (e.g., the highest weight coefficient may be applied during the high demand periods while the lowest weight coefficient may be applied outside of high demand periods).

One or more “soft constraints” may be related to the worker satisfaction.

Accordingly, the job satisfaction, measurable by one or more job satisfaction metrics, may be reflected by one or more additive terms of the objective function, such that each additive term would affect the value of the objective function proportionally to the deviation, from the desired value, of a metric characterizing the respective worker satisfaction aspect. In an illustrative example, a worker satisfaction metric may reflect the deviation between the worker's desired number of hours and the scheduled number of hours during a particular time period. In another illustrative example, a worker satisfaction metric may reflect the share of the total number of scheduled shifts for the worker that fall within the worker preferred time windows. In another illustrative example, a worker satisfaction metric may reflect a number of non-consecutive days off scheduled for the worker during a particular time period. In some implementations, one or more worker satisfaction metrics may be weighted by a set of coefficients reflecting respective worker seniorities.

One or more “soft constraints” may be related to the budgetary aspects of the schedule. Accordingly, the economic efficiency of the schedule, measurable by one or more economic efficiency metrics, may be reflected by one or more additive terms of the objective function, such that each additive term would affect the value of the objective function proportionally to the deviation, from the desired value, of a metric characterizing the respective economic efficiency aspect. In an illustrative example, an economic efficiency metric may reflect the increase in the total labor cost due to scheduled overtime shifts (which attract additional payments to the workers). In another illustrative example, an economic efficiency metric may reflect the costs of transporting one or more workers to their respective scheduled job placements outside of their regular geographic area. In another illustrative example, an economic efficiency metric may reflect the costs of scheduling overqualified workers to respective one or more jobs.

One or more “soft constraints” may be related to various other metrics characterizing various aspects of the schedule. Each aspect may be reflected by a respective additive term of the objective function, such that each additive term would affect the value of the objective function proportionally to the deviation, from the desired value, of a metric characterizing the respective aspect of the schedule. In an illustrative example, a schedule stability metric may reflect the difference between the current schedule and a schedule for a past period. In another illustrative example, a schedule alignment metric may reflect the difference between shift start times for a particular worker. In another illustrative example, an open shift distribution metric alignment metric may reflect the difference between the scheduled and the desired distribution of open shifts.

As noted herein above, certain scheduling rules may be translated into “hard” constraints of the scheduling problem. In an illustrative example, a subset of scheduling rules may specify skills, qualifications, and/or certifications that are necessary for performing certain jobs. In another illustrative example, a subset of scheduling rules may regulate the worked hours, time of day, time off, holidays, mandatory breaks, mandatory rest, etc. In another illustrative example, a subset of scheduling rules may establish the job priorities, e.g., requiring that job A be always chosen over job B if the two jobs compete for a single resource. In another illustrative example, a subset of scheduling rules may establish the worker priorities, e.g., based on their respective seniority. In another illustrative example, a subset of scheduling rules may prescribe the maximum number of consecutive working days, maximum number of working nights per week, maximum number of consecutive working nights, etc. In another illustrative example, a subset of scheduling rules may regulate various aspects of work performed by minors and/or other protected categories. Accordingly, these and various other scheduling rules may be translated into respective one or more constraints 130A-130P, which must be complied with by a valid solution of the scheduling problem 1000.

Thus, as noted herein above, the scheduling problem 1000 optimizes the objective function value 122 of the objective function 120 subject to the constraints 130A-130P.

As noted herein above, if the dimensionality of the scheduling problem falls below a predefined threshold, the scheduling problem may be solved based on enumerating the candidate shifts.

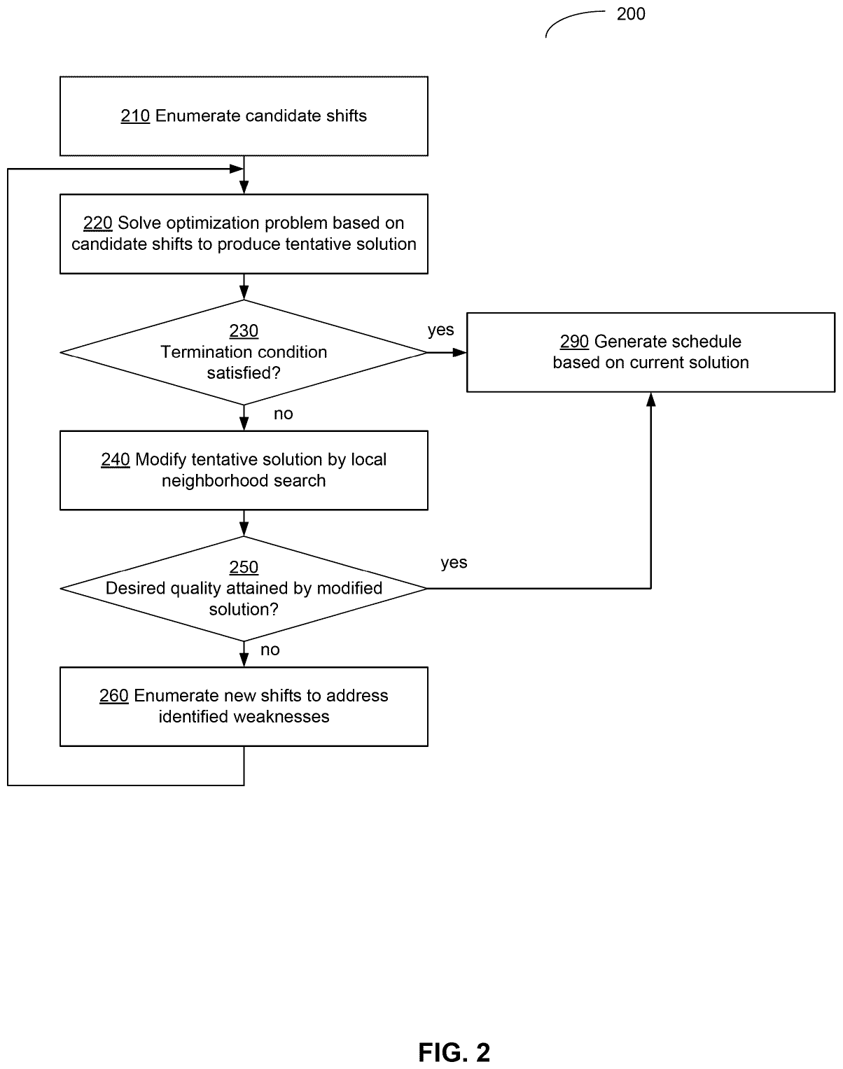

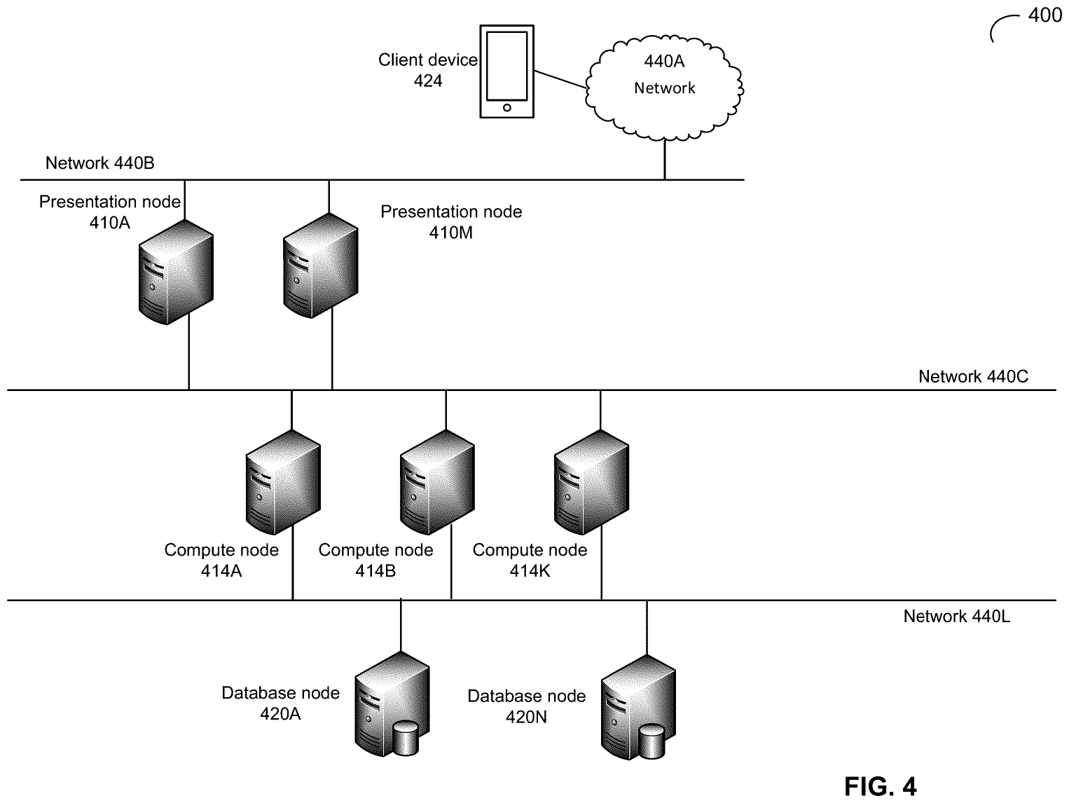

FIG. 2 depicts a flow diagram of an example workflow 200 of solving a workforce scheduling problem by shift enumeration, in accordance with aspects of the present disclosure. The workflow 200 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, the workflow 200 is performed by the one or more execution environments (e.g., nodes 410, 414, 420 of FIG. 4), including one or more processes, processing threads, virtual or physical machines. In some implementations, the workflow 200 may be performed by a single execution environment. Alternatively, the workflow 200 may be performed by two or more execution environments, such that each execution environment may perform one or more individual functions, routines, subroutines, or operations of the workflow. In an illustrative example, the execution environments implementing the workflow 200 may be synchronized (e.g., using messages, semaphores, critical sections, and/or other synchronization mechanisms). Alternatively, the execution environments implementing the workflow 200 may be executed asynchronously with respect to each other. Although shown in a particular sequence or order, unless otherwise specified, the order of the operations may be modified. Some operations may be performed in parallel. Additionally, one or more operations may be omitted in some implementations. Thus, not all illustrated operations are required in every implementation, and other process flows are possible.

As schematically illustrated by FIG. 2, the workflow 200 starts with generating an initial set of variables by enumerating, at operation 210, the candidate shifts that satisfy the pertinent constraints of the scheduling problem. In some implementations, the candidate shifts may be generated based on a historic schedule associated with one or more previous time periods, for at least a subset of jobs and/or at least a subset of workers.

In an illustrative example, for each worker, a subset of most frequently worked jobs and corresponding historic shifts may be selected from the historic schedule; alternatively, the historic shifts associated with at least a subset of jobs of the scheduling scope may be selected from the historic schedule.

Then, the corresponding historic shifts may be identified in which the worker was assigned to work one of their most frequently worked jobs (or one of the chosen subset of jobs). Then, candidate shifts may be generated, such that each candidate shift would begin and/or end within a certain timeframe from respective start or end times of a historic shift; during the candidate shift, the worker would be assigned to perform the same job that was performed during the historic shift.

In some implementations, only the candidate shifts that have the start time within a certain timeframe of a predicted demand rise time may be included into the initial set of shifts forming the basis for the initial set of variables. Furthermore, only the candidate shifts that have the end time within a certain timeframe of a predicted demand drop time may be included into the initial set of shifts. The demand rise and drop time may be predicted, e.g., based on historic data reflecting the demands associated with the jobs to be scheduled.

In some implementations only the candidate shifts that satisfy one or more schedule quality criteria (e.g., worker preferences with respect to jobs and/or hours) may be included into the initial set of shifts.

Based on the enumerated shifts, an initial sub-set of decision variables for the optimization problem 1000 is identified.

At operation 220, the optimization problem 1000 is solved as a MILP problem, e.g., by applying one or more mathematical programming techniques to the initial solution generated at operation 210. The solution is the optimization problem 1000 serves as a tentative schedule.

Responsive to determining, at operation 230, that a chosen workflow termination condition is satisfied (e.g., the desired quality of the schedule measured by the value of the objective function of the optimization problem 1000 is attained or a predefined threshold number of workflow iterations have been performed), the final schedule is generated at operation 290 based on the tentative schedule; otherwise, the workflow continues at operation 240.

At operation 240, the tentative solution of the optimization problem 1000 may be modified, e.g., by applying one or more local neighborhood search methods. In an illustrative example, at each iteration of the search-based method, the values of decision variables of the current tentative solution are modified within a pre-defined vicinity of the current tentative solution in accordance with a chosen search strategy. In an illustrative example, the search strategy may call for randomly generating a predefined number of points within a predefined distance, in the multidimensional space of the decision variables, from the current tentative solution. This action may be analogous to introducing a minor modification into the tentative (e.g., increasing or decreasing a scheduled shift by a small period of time, such as one hour; moving the start of a scheduled shift by a small period of time, such as one hour; or swapping two scheduled shifts) in an attempt to improve the value of the objective function. The point that exhibits a better value of the objective function while satisfying the constraints may then be chosen as the new tentative solution. The iterations may continue until the current solution can no longer be improved or a predefined termination condition for the search is satisfied (e.g., a predefined threshold number of search iterations have been performed).

Responsive to determining, at operation 250, that the desired quality of the schedule measured by the value of the objective function of the optimization problem 1000 is attained, the final schedule is generated at operation 290 based on the tentative solution; otherwise, the workflow continues at operation 260.

At operation 260, the sub-set of variables of the optimization problem 1000 may be modified by enumerating new shifts for identified weaknesses in the tentative schedule derived from the tentative solution. In an illustrative example, the tentative schedule may be analyzed to identify one or more sub-schedules that exhibit unsatisfactory quality (e.g., if a value of a chosen quality metric exhibited by the sub-schedule differs, by at least a predefined threshold value, from a desired value). “Sub-schedule” herein shall refer to any subset of the original schedule, which may be defined, e.g., by any combination of at least a subset of time periods of the original schedule, at least a subset of workers of the original schedule, and at least a subset of jobs of the original schedule. In an illustrative example, a sub-schedule may be defined based on a chosen grouping criterion (e.g., a combination of organizational boundaries, geographic boundaries, job categories, time periods, etc.). In another illustrative example, a sub-schedule may be represented by a subset of the original schedule limited to a subset of workers. The chosen quality metric to be applied for selecting the sub-schedule can be represented by at least a subset of additive terms of the objective function of the optimization problem 1000, from which the decision variables are removed that are not relevant for the chosen grouping of scheduled shifts.

For each identified sub-schedule, one or more shifts of the sub-schedule can be deleted from the sub-schedule and new shifts may be enumerated to replace the deleted shifts. The subset of variables of the scheduling problem may then be modified accordingly, to reflect the deleted and/or newly added shifts. The workflow may then loop back to operation 220.

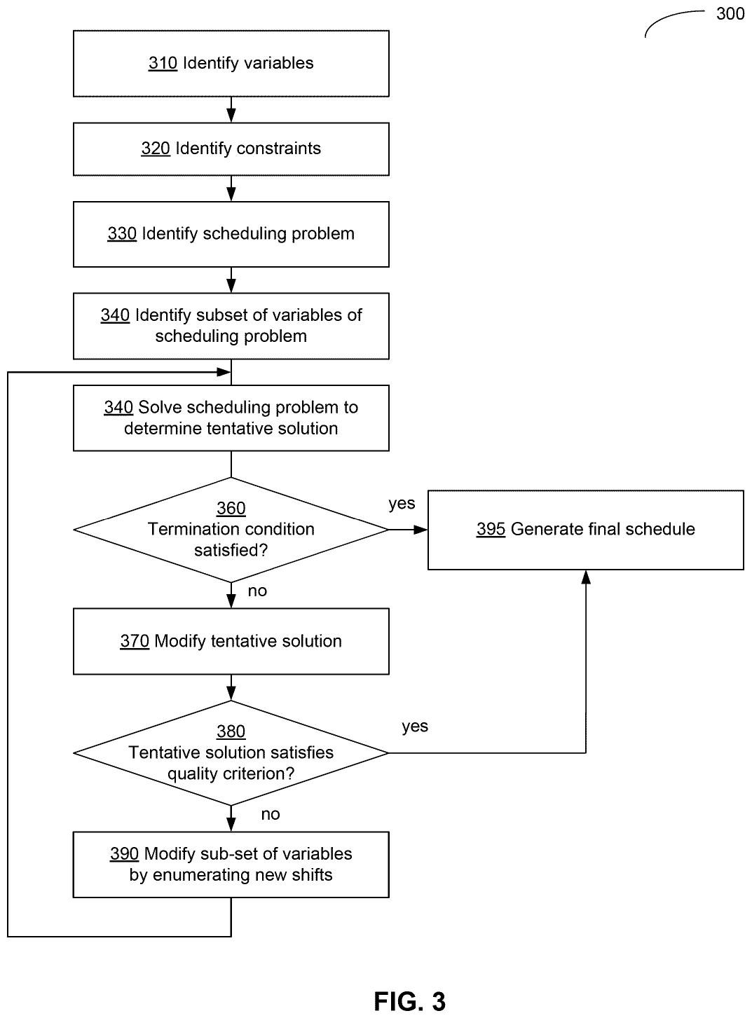

FIG. 3 depicts a flow diagram of an example method of generating a workforce schedule by shift enumeration, in accordance with aspects of the present disclosure. The method 300 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, the method 300 is performed by the one or more execution environments (e.g., nodes 410, 414, 420 of FIG. 4), including one or more processes, processing threads, virtual or physical machines. In some implementations, the method 300 may be performed by a single execution environment. Alternatively, the method 300 may be performed by two or more execution environments, such that each execution environment may perform one or more individual functions, routines, subroutines, or operations of the method. In an illustrative example, the execution environments implementing the method 300 may be synchronized (e.g., using messages, semaphores, critical sections, and/or other synchronization mechanisms). Alternatively, the execution environments implementing the method 300 may be executed asynchronously with respect to each other. Although shown in a particular sequence or order, unless otherwise specified, the order of the operations may be modified. Some operations may be performed in parallel. Additionally, one or more operations may be omitted in some implementations. Thus, not all illustrated operations are required in every implementation, and other process flows are possible.

At operation 310, the processing logic implementing the method identifies a plurality of variables associated with scheduling a plurality of workers to perform a plurality of jobs during a plurality of time periods, as described in more detail herein above. In some implementations, the processing logic may receive descriptions of the variables via a graphical user interface (GUI) or an application programming interface (API). Alternatively, the processing logic may generate the variables by analyzing historical schedules and/or pertinent scheduling rules.

At operation 320, the processing logic identifies a plurality of constraints associated with the plurality of variables, as described in more detail herein above. In some implementations, the processing logic may receive descriptions of the constraints via a graphical user interface (GUI) or an application programming interface (API). Alternatively, the processing logic may generate the constraints by analyzing the pertinent scheduling rules.

At operation 330, the processing logic identifies a scheduling problem for optimizing an objective function defined on the plurality of variables subject to the plurality of constraints, as described in more detail herein above. In some implementations, the processing logic may receive a description of the scheduling problem via a graphical user interface (GUI) or an application programming interface (API). Alternatively, the processing logic may generate a definition of the scheduling problem by analyzing historical schedules and/or pertinent scheduling rules.

At operation 340, the processing logic generates, based on a historic schedule assigning at least a subset of the plurality of workers to perform at least a subset of the plurality of jobs during a plurality of past time periods, an initial set of shifts that would form the basis for identifying the initial subset of variables of the scheduling problem. In some implementations, generating the initial set of shifts involves identifying a subset of jobs of the historic schedule that were most frequently assigned to a particular worker, identifying a plurality of shifts during which the particular worker was assigned by the historic schedule to perform a job of the subset of jobs, and appending the plurality of shifts to the initial solution. In some implementations, generating the initial set of shifts involves identifying a subset of shifts of the historic schedule, and, for each shift of the subset of shifts, appending, to the initial solution, a shift that starts within a predefined timeframe from the start time or ends within a predefined timeframe from the end time of that shift. In some implementations, generating the initial set of shifts involves identifying a subset of shifts of the historic schedule, and, for each shift of the subset of shifts, appending that shift to the initial solution if the shift starts within a predefined timeframe from a predicted demand rise time or ends within a predefined timeframe from a predicted demand drop time, as described in more detail herein above.

At operation 350, the processing logic determines, based on the initial subset of variables, a tentative solution of the scheduling problem (e.g., by applying mathematical programming techniques).

Responsive to determining, at operation 360, that a chosen termination condition is satisfied (e.g., the desired quality of the schedule measured by the value of the objective function of the optimization problem 1000 is attained or a predefined threshold number of method iterations have been performed), the final schedule is generated at operation 395 based on the current solution of the scheduling problem; otherwise, the method continues at operation 370.

At operation 370, the processing logic modifies the tentative solution. In some implementations, modifying the tentative solution may involve modifying the start time of a chosen shift of the tentative solution, modifying the end time of a chosen shift of the tentative solution, modifying the duration of a chosen shift of the tentative solution, or swapping two shifts of the tentative solution. In some implementations, modifying the tentative solution may involve replacing one or more shifts of a chosen sub-schedule of the tentative solution, as described in more detail herein above.

Responsive to determining, at operation 380, that the tentative solution satisfies the predefined quality criterion, the processing logic, at operation 395, generates, based on the tentative solution, the final schedule to assign at least the plurality of workers to perform at least the plurality of jobs during at least the plurality of time periods, as described in more detail herein above.

Responsive to determining, at operation 380, that the tentative solution fails the predefined quality criterion, the processing logic, at operation 390, modifies the sub-set of variables of the optimization problem by enumerating new shifts for identified weaknesses in the tentative solution. For each identified weak sub-schedule of the tentative solution (e.g., sub-schedule that exhibits an unsatisfactory value of a chosen quality metric), one or more shifts of the sub-schedule can be deleted from the sub-schedule and new shifts may be enumerated to replace the deleted shifts. The subset of variables of the scheduling problem may then be modified accordingly, to reflect the deleted and/or newly added shifts, as described in more detail herein above. The method may then loop back to operation 340.

Examples of decision variables and constraints are described below.

The principal decision variables represent several subcases: the assignment of a shift prototype to an employee at a given date, the assignment of a rest to an employee at given date, and the assignment of a shift prototype to the Bank at a given date:

$${x}_{c l} = \{ \begin{matrix}1 & if column c is assigned to line l \\ 0 & otherwise\end{matrix}$$

Subsidiary decision variables that are used to ensure the respect of a minimum rest between shifts; for each employee-date element of the schedule (“cell”), the scheduling method will return a value that first is greater than or equal to the start of the first shift scheduled from the cell date; for the employee-date cell, the value returned by the scheduling method will also be lower than or equal to the end of the last shift scheduled up to the cell date:

$${w}_{l} \qquad \{ \begin{matrix}= \{ \begin{matrix}lower bound on the start of the first shift \\ belonging to a date equal to or later than \\ l ' s date ;\end{matrix} \\ = \{ \begin{matrix}upper bound on the end augmented by the \\ minimum rest duration of the last shift \\ belonging to a date equal to or earlier \\ than l ' s date .\end{matrix}\end{matrix}$$

Subsidiary decision variables are used identify the occurrence of a given sequence starting at the cell date for the cell employee for each employee-date cell; these variables are used to control the number of the sequence occurrences inside a given interval of a given employee rule; “Controlling a Quantity” means to lower and/or upper bound in a hard and/or soft way; when appropriate, there endless ways to control softly a quantity: typically piece-wise linearly and in a convex way.

$${v}_{sl} = \{ \begin{matrix}1 & if sequence s is realized from l ' s date \\ 0 & otherwise\end{matrix}$$

The following example constraints state that each employee-date cell should be assigned either a shift prototype, an initial open shift, or a rest day:

Σ_{c}x_{cl}=1∀l↔employee→<LINE CONTROL: one shift or rest to each employee>

The following example constraints state that each initial open shift must be assigned either to an employee-date cell or to the Bank (i.e., stay open):

Σₗx_{cl}=1∀c↔initial shift→<COLUMN CONTROL: preserve initial shifts>

The following constraints set the lower bound nature of the “minimum rest” subsidiary decision variables.

$$\begin{matrix}{w}_{l} & \leq & \begin{matrix}{\sum }_{cl ′} {α}_{l ′ l}^{d ′} \cdot {w}_{c} \cdot {x}_{cl ′} & ∀ l , d ↔ l , {d}^{′} ∈ [ d , … , d + rest ]\end{matrix} \\ {w}_{c} & = & \{ \begin{matrix}its start & if c is a shift \\ M & otherwise\end{matrix} \\ {α}_{l ′ l}^{d ′} & = & \{ \begin{matrix}1 & if {l}^{′} ↔ {d}^{′} and if {l}^{′} and l share the same employee \\ 0 & otherwise\end{matrix}\end{matrix}$$

The following example constraints set the upper bound nature of the “minimum rest” subsidiary decision variables:

$$\begin{matrix}{w}_{l} & \geq & \begin{matrix}{\sum }_{cl ′} {α}_{l ′ l}^{d ′} \cdot ( {v}_{c} + {δ}_{c}^{r} ) \cdot {x}_{cl ′} & ∀ l , d ↔ l , {d}^{′} ∈ [ d - rest , … , d ]\end{matrix} \\ & {v}_{c} = & \{ \begin{matrix}its end & if c is a shift \\ - M & otherwise\end{matrix} \\ & {δ}_{c}^{r} = & \{ the minimum rest duration after c according to r \\ {α}_{l ′ l}^{d ′} & = & \{ \begin{matrix}1 & if {l}^{′} ↔ {d}^{′} and if {l}^{′} and l share the same employee \\ 0 & otherwise\end{matrix}\end{matrix}$$

The following example constraints set occurrence nature of the “sequence identification” subsidiary decision variables:

$${n}_{s} \cdot {v}_{s l} \qquad \leq {\sum }_{ecl ′} {γ}_{l ′ l}^{e s} \cdot {α}_{cl ′}^{e} \cdot {x}_{cl ′} \qquad \leq \qquad {n}_{s} - 1 + {v}_{s l} \qquad ∀ s , l$$

$${n}_{s} \qquad = \qquad size of sequence s$$

$${α}_{cl ′}^{e} \qquad = \qquad \{ \begin{matrix}1 & if event e is realised by the ( c , l ) assignmnet ; \\ 0 & otherwise \\ & \end{matrix}$$

$${γ}_{l ′ l}^{e s} = \{ \begin{matrix}1 & \begin{matrix}if l and {l}^{′} share the same employee and if e \\ matches position {l}^{′} in s when the latter is \\ realised from l ;\end{matrix} \\ 0 & otherwise\end{matrix}$$

The following example constraints (expressed in the form of objective functions) control over/under coverage for each time subdivision, workload, and requirement by cumulating the contributions of scheduled shifts:

$${\sum }_{c l} \qquad {α}_{c l}^{tn} {x}_{cl} \qquad {\to }^{controlled} \qquad f ( n , t ) \qquad ∀ n , t$$

$${α}_{c l}^{t n} = \{ \begin{matrix}1 & if c is a shift covering n at t \\ 0 & otherwise\end{matrix}$$

The following example constraints (expressed in the form of objective functions) control open shift coverage for each time subdivision, workload, and requirement by cumulating the contributions of scheduled shifts; the open shift coverage corresponds to either overtime costs or to use of an external agency:

$${\sum }_{c l} \qquad {α}_{c l}^{′ tn} {x}_{cl} \qquad {\to }^{controlled} \qquad 0 \qquad ∀ n , t$$

$${α}_{c l}^{′ tn} = \{ \begin{matrix}1 & \begin{matrix}if c is a shift covering n at t \\ and if l ↔ unassigned schedule\end{matrix} \\ 0 & otherwise\end{matrix}$$

The following example constraints (expressed in the form of objective functions) implement “controlled account” rules; such a rule cumulates daily credits over a given horizon and can correspond to worked hours per week, worked days per week, worked nights per months, etc. The “controlled account” is an abstraction that covers several if not the majority of the concrete rules handled by the scheduling method.

$${\sum }_{c} {β}_{cl}^{r} {x}_{cl} \qquad {\to }^{controlled} \qquad f ( r ) \qquad ∀ l , r ↔ controlled account and l$$

$${β}_{c l}^{r} \qquad = \qquad \{ contribution of the ( c , l ) assignmnet to r$$

The following example constraints (expressed in the form of objective functions) implement “controlled sequence” rules; such a rule cumulates the occurrences of a given sequence over a given horizon and can correspond to worked day to rest day, three or more consecutive nights, consecutive worked days, . . . . The “controlled sequence” is an abstraction that covers several of the concrete rules handled by the scheduling method.

$${\sum }_{sl} {α}_{sl}^{r} {v}_{sl} \qquad {\to }^{controlled} \qquad f ( r ) \qquad ∀ r ↔ controlled sequence$$

$${α}_{sl}^{r} = \{ \begin{matrix}1 & if r concerns the realisation of s from l \\ 0 & otherwise\end{matrix}$$

The following indexes are used be the above-described examples:

l denotes a line corresponding either to a cell of an employee schedule (i.e. the employee and date pair) or to a cell of the unassigned schedule (i.e. the unassigned row and date pair); the unassigned schedule is made of all open shifts that should subsequently be assigned to employees in extra-time for instance. It is also called the Bank, or the open shift set.

c denotes a column corresponding either to a shift prototype, or to an initial shift, or to a dated rest; a shift prototype is pre-enumerated dated and unassigned; it could be used in a decision zero to several times; each time it is used, an instance is taken. The shift enumeration is made in accordance with the shift construction rules.

r denotes a fixed schedule rule (i.e., a rule with given horizon and employee;) examples of such a rule are at most 40 hours worked over the 5th week of 2024; no more than 6 consecutive worked shifts over an unlimited horizon.

e denotes a floating cell event (i.e., an event without given date and employee;) for instance: a rest is assigned; a night shift is worked; a weekend shift is worked.

s denotes a floating cells sequence (i.e., a sequence without given start date and employee) for instance: (“night shift”, “night shift”, “night shift”) or (“worked day”, “rest day”).

FIG. 4 schematically illustrates a high-level diagram of an example distributed computer system 400, which may implement the methods described herein. Nodes, appliances, and network segments are shown in FIG. 4 for illustrative purposes only and do not in any way limit the scope of the present disclosure. Various other nodes, components, appliances, and/or methods of their interconnection may be compatible with the methods and systems described herein. Firewalls, load balancers, network switches and various other networking components may be omitted from FIG. 4 for clarity and conciseness.

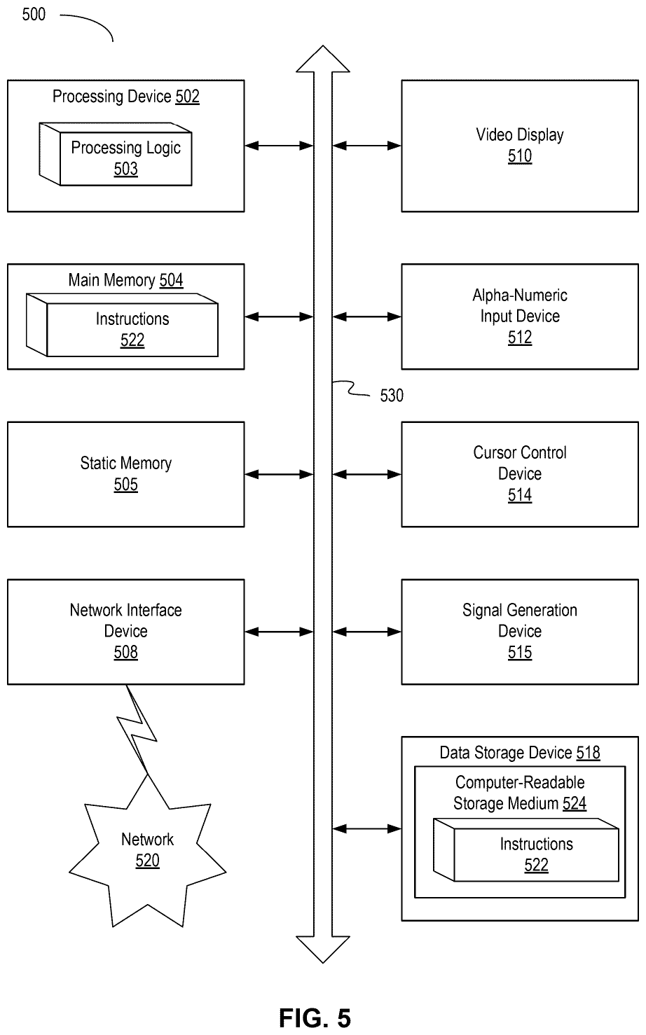

Each node in FIG. 4 may represent an isolated or shared execution environment, such as a virtual machine or a physical server. The functional designation of nodes in FIG. 4 does not necessarily corresponds to the physical boundaries between corresponding environments, e.g., the same physical server may perform the functions of one or more compute nodes, one or more database nodes, and/or one or more presentations nodes. In another illustrative example, the functions of each node of FIG. 4 are performed by a dedicated physical server. In another illustrative example, the functions of each node of FIG. 4 are performed by a dedicated virtual machine (e.g., operating in a private, public, or hybrid cloud environment). In some implementations, one or more nodes of FIG. 4 may be implemented by example computer system 500 of FIG. 5.

The example distributed computer system 400 may include one or more presentation nodes 410A-410M, compute nodes 414A-414K, database nodes 420A-420N, and/or various other nodes interconnected by one or more networks 440A-440L. The networks 440A-440L may be represented by one or more private networks and/or one or more public networks, including wired, wireless, and/or virtual networks.

The compute nodes 414A-414K perform the scheduling methods described herein. The compute nodes 414A-414K may access database nodes 420A-420N for retrieving the information to be used for solving the scheduling problems (e.g., organizational structure, historic schedules, scheduling rules, and/or various other information). The schedules produced by compute nodes 414A-414K may also be stored on database nodes 420A-420N.

In some implementations, the schedules produced by compute nodes 414A-414K may be supplied to the presentation nodes 410A-410M, which may convert the schedules into a representation (e.g., HTML-based representation) that may be rendered by one or more client devices 424. Each client device 424 may be represented, e.g., by a laptop, a desktop computer, a smartphone, a tablet, or other mobile or stationary computing device. In some implementations, the client devices may be employed for supplying, to the compute nodes 414A-414K, various information that may be utilized for computing the schedules (e.g., updates to organizational structure, scheduling rules, worker availability, etc.).

The above-described architecture of the example distributed computer system 400 serves as an illustrative example only and does not in any way limit the scope of the present disclosure. References herein to presentation nodes, compute nodes, database nodes, and/or other components of example distributed computer systems are purely functional, as a single hardware system or a single software component may implement functions of one or more functional components that are described or referenced herein. Various other system architectures may be compatible with the methods and systems implemented in accordance with one or more aspects of the present disclosure.

FIG. 5 depicts an example computer system 500 that may perform any one or more of the methods described herein, in accordance with some implementations of the present disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 500 includes a processing device 502, a main memory 504 (e.g., read-only memory (ROM), flash memory, dynamic random access memory (DRAM) such as synchronous DRAM (SDRAM)), a static memory 505 (e.g., flash memory, static random access memory (SRAM)), and a data storage device 518, which communicate with each other via a bus 530.

Processing device 502 (which may include processing logic 503) represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute instructions 522 for implementing the methods described herein (e.g., methods 200, 300).

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., a speaker). In one illustrative example, the video display unit 510, the alphanumeric input device 512, and the cursor control device 514 may be combined into a single component or device (e.g., an LCD touch screen).

The data storage device 518 may include a computer-readable storage medium 524 on which is stored the instructions 522 embodying any one or more of the methodologies or functions described herein. The instructions 522 may also reside, completely or at least partially, within the main memory 504 and/or within the processing device 502 during execution thereof by the computer system 500, the main memory 504 and the processing device 502 also constituting computer-readable media. In some implementations, the instructions 522 may further be transmitted or received over a network 520 via the network interface device 508.

While the computer-readable storage medium 524 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method, comprising:
identifying, by a processing device, a plurality of variables associated with scheduling a plurality of workers to perform a plurality of jobs during respective shifts defined by corresponding time periods, wherein each variable of the plurality of variables is associated with a corresponding shift;
identifying a plurality of constraints associated with the plurality of variables;
identifying a scheduling problem for optimizing an objective function defined on the plurality of variables subject to the plurality of constraints;
identifying, based on a historic schedule assigning at least a subset of the plurality of workers to perform at least a subset of the plurality of jobs during a plurality of past time periods, a subset of the plurality of variables of the scheduling problem;
determining, based on the subset of the plurality of variables, a tentative solution of the scheduling problem;
responsive to determining that the tentative solution fails a predefined quality criterion, modifying the tentative solution; and
generating, based on the tentative solution, a schedule to assign at least the plurality of workers to perform at least the plurality of jobs during at least the plurality of time periods.

2. The method of claim 1, further comprising:
responsive to determining that the tentative solution fails a predefined quality criterion, modifying the subset of the plurality of variables of the scheduling problem.

3. The method of claim 1, wherein identifying the subset of the plurality of variables further comprises:
identifying, in the historic schedule, a subset of jobs that were most frequently assigned to a particular worker;
identifying, in the historic schedule, a plurality of shifts during which the particular worker was assigned to perform a job of the subset of jobs; and
appending, to the subset of variables, one or more variables associated with the plurality of shifts.

4. The method of claim 1, wherein identifying the subset of the plurality of variables further comprises:
identifying a subset of shifts of the historic schedule; and
for each shift of the subset of shifts, identify a start time and an end time of the shift;
append, to the subset of variables, one or more variables associated with at least one of: a first shift that starts within a predefined timeframe from the start time or a second shift that ends within a predefined timeframe from the end time.

5. The method of claim 1, wherein identifying the subset of the plurality of variables further comprises:
identifying a subset of shifts of the historic schedule; and
for each shift of the subset of shifts, identify a start time of the shift;
responsive to determining that the start time is within a predefined timeframe of a predicted demand rise time, appending, to the subset of variables, one or more variables associated with the shift.

6. The method of claim 1, wherein identifying the subset of the plurality of variables further comprises:
identifying a subset of shifts of the historic schedule; and
for each shift of the subset of shifts, identify an end time of the shift;
responsive to determining that the end time is within a predefined timeframe of a predicted demand drop time, appending, to the subset of variables, one or more variables associated with the shift.

7. The method of claim 1, wherein modifying the tentative solution further comprises performing at least one of: modifying a start time of a chosen shift of the tentative solution, modifying an end time of a chosen shift of the tentative solution, modifying duration of a chosen shift of the tentative solution, or swapping a first shift and a second shift of the tentative solution.

8. The method of claim 1, wherein modifying the tentative solution further comprises:
identifying a sub-schedule of a tentative solution; and
replacing one or more shifts of the sub-schedule.

9. A system, comprising:
a memory; and
a processing device coupled to the memory, the processing device configured to:
identify a plurality of variables associated with scheduling a plurality of workers to perform a plurality of jobs during respective shifts defined by corresponding time periods, wherein each variable of the plurality of variables is associated with a corresponding shift;
identify a plurality of constraints associated with the plurality of variables;
identify a scheduling problem for optimizing an objective function defined on the plurality of variables subject to the plurality of constraints;
identify, based on a historic schedule assigning at least a subset of the plurality of workers to perform at least a subset of the plurality of jobs during a plurality of past time periods, a subset of the plurality of variables of the scheduling problem;
determine, based on the subset of the plurality of variables, a tentative solution of the scheduling problem;
responsive to determining that the tentative solution fails a predefined quality criterion, modify the tentative solution; and
generate, based on the modified tentative solution, a schedule to assign at least the plurality of workers to perform at least the plurality of jobs during at least the plurality of time periods.

10. The system of claim 9, wherein identifying the subset of the plurality of variables further comprises:
identifying, in the historic schedule, a subset of jobs that were most frequently assigned to a particular worker;
identifying, in the historic schedule, a plurality of shifts during which the particular worker was assigned to perform a job of the subset of jobs; and
appending, to the subset of variables, one or more variables associated with the plurality of shifts.

11. The system of claim 9, wherein identifying the subset of the plurality of variables further comprises:
identifying a subset of shifts of the historic schedule; and
for each shift of the subset of shifts, identify a start time and an end time of the shift;
append, to the subset of variables, one or more variables associated with at least one of: a first shift that starts within a predefined timeframe from the start time or a second shift that ends within a predefined timeframe from the end time.

12. The system of claim 9, wherein identifying the subset of the plurality of variables further comprises:
identifying a subset of shifts of the historic schedule; and
for each shift of the subset of shifts, identify a start time of the shift;
responsive to determining that the start time is within a predefined timeframe of a predicted demand rise time, appending, to the subset of variables, one or more variables associated with the shift.

13. The system of claim 9 wherein identifying the subset of the plurality of variables further comprises:
identifying a subset of shifts of the historic schedule; and
for each shift of the subset of shifts, identify an end time of the shift;
responsive to determining that the end time is within a predefined timeframe of a predicted demand drop time, appending, to the subset of variables, one or more variables associated with the shift.

14. The system of claim 9, wherein modifying the tentative solution further comprises performing at least one of: modifying a start time of a chosen shift of the tentative solution, modifying an end time of a chosen shift of the tentative solution, modifying duration of a chosen shift of the tentative solution, or swapping a first shift and a second shift of the tentative solution.

15. A computer-readable non-transitory storage medium comprising executable instructions that, when executed by a processing device, cause the processing device to:
identify a plurality of variables associated with scheduling a plurality of workers to perform a plurality of jobs during respective shifts defined by corresponding time periods, wherein each variable of the plurality of variables is associated with a corresponding shift;
identify a plurality of constraints associated with the plurality of variables;
identify a scheduling problem for optimizing an objective function defined on the plurality of variables subject to the plurality of constraints;
identify, based on a historic schedule assigning at least a subset of the plurality of workers to perform at least a subset of the plurality of jobs during a plurality of past time periods, a subset of the plurality of variables of the scheduling problem;
determine, based on the subset of the plurality of variables, a tentative solution of the scheduling problem;
responsive to determining that the tentative solution fails a predefined quality criterion, modify the tentative solution; and
generate, based on the modified tentative solution, a schedule to assign at least the plurality of workers to perform at least the plurality of jobs during at least the plurality of time periods.

16. The computer-readable non-transitory storage medium of claim 15, wherein identifying the subset of the plurality of variables further comprises:
identifying, in the historic schedule, a subset of jobs that were most frequently assigned to a particular worker;
identifying, in the historic schedule, a plurality of shifts during which the particular worker was assigned to perform a job of the subset of jobs; and
appending, to the subset of variables, one or more variables associated with the plurality of shifts.

17. The computer-readable non-transitory storage medium of claim 15, wherein identifying the subset of the plurality of variables further comprises:
identifying a subset of shifts of the historic schedule; and
for each shift of the subset of shifts, identify a start time and an end time of the shift;
append, to the subset of variables, one or more variables associated with at least one of: a first shift that starts within a predefined timeframe from the start time or a second shift that ends within a predefined timeframe from the end time.

18. The computer-readable non-transitory storage medium of claim 15, wherein identifying the subset of the plurality of variables further comprises:
identifying a subset of shifts of the historic schedule; and
for each shift of the subset of shifts, identify a start time of the shift;
responsive to determining that the start time is within a predefined timeframe of a predicted demand rise time, appending, to the subset of variables, one or more variables associated with the shift.

19. The computer-readable non-transitory storage medium of claim 15, wherein modifying the tentative solution further comprises performing at least one of: modifying a start time of a chosen shift of the tentative solution, modifying an end time of a chosen shift of the tentative solution, modifying duration of a chosen shift of the tentative solution, or swapping a first shift and a second shift of the tentative solution.

20. The computer-readable non-transitory storage medium of claim 15, wherein modifying the tentative solution further comprises:
identifying a sub-schedule of a tentative solution; and
replacing one or more shifts of the sub-schedule.
